(19) United States
(12) Patent Application Publication
(10) Pub. No.: US 2008/0067827 A1
(43) Pub. Date: Mar. 20, 2008

(54) VEHICLE OVERHEAD CONSOLE ASSEMBLY HAVING A COMBINATION MIRROR AND STORAGE BIN ASSEMBLY

(75) Inventors: John M. Tiesler, Harrison Township, MI (US); James R. Mestemaker, Lambertville, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/533,526

(22) Filed: Sep. 20, 2006

(51) Int. Cl. B60R 7/00

(52) U.S. Cl. 296/37.7

(57) ABSTRACT

The present invention relates to a vehicle overhead console assembly supportable in a vehicle. In at least one embodiment, the console assembly comprises a console body, an actuator slidably supported by the console body between a first position and a second position, and a storage bin pivotally connected to the console body. The storage bin is pivotally movable between a stowed position, a first use position, and a second use position. The storage bin has a mirror secured thereto. The storage bin has a stop tab that is selectively engageable with a stop surface of the actuator to enable the storage bin to selectively pivot to the first or second use position.

### BACKGROUND OF THE INVENTION

1. Field of the Invention

The present invention relates to a vehicle overhead console assembly having a combination mirror and storage bin assembly.

2. Background Art

Vehicle overhead console assemblies are known. Examples of known vehicle overhead consoles include U.S. Pat. Nos. D512,973, 4,469,365; 5,050,922; 5,775,761; and 7,055,883.

### SUMMARY OF THE INVENTION

According to at least one aspect of the present invention, a vehicle overhead console assembly is provided. In at least one embodiment, the vehicle overhead console assembly comprises a vehicle overhead console assembly supportable in a vehicle having an occupant compartment. In at least this embodiment, the console assembly comprises a console body having an exterior surface facing a first direction and an interior surface facing a second, opposite direction. The first direction faces the occupant compartment when the console assembly is supported in the vehicle and the second direction faces away from the occupant compartment when the console assembly is supported in the vehicle. In at least this embodiment, the overhead console assembly further comprises an actuator slidably supported by the console body between a first position and a second position. The actuator, in at least this embodiment, includes a button portion located adjacent the exterior surface, a stop surface located adjacent the interior surface of the console body, and a connector portion extending between and connecting the actuator and the stop surface. In at least this embodiment, the overhead console assembly further comprises a storage bin pivotally connected to the console body for pivotal movement between a stowed position, a first use position, and a second use position. In at least this embodiment, the storage bin has a door which is generally flush with the exterior surface of the console body when the storage bin is in the stowed position. The storage bin has at least one wall forming a storage compartment in combination with the door and a mirror secured to the wall. In at least one embodiment, the storage bin has a stop tab that is selectively engageable with the stop surface of the actuator to enable the storage bin to selectively pivot to the first or second use position.

In at least another embodiment, the vehicle overhead console assembly comprises a console body having an exterior surface facing a first direction, an interior surface facing a second, opposite direction, an actuator slidably supported by the console body between a first position and a second position, and having a stop surface, and a storage bin pivotally connected to the console body. The storage bin is pivotally movable between a stowed position, a first use position, and a second use position. In at least one embodiment, the storage bin has a door having at least a substantial portion flush with the exterior surface of the console body when the storage bin is in the stowed position, and a storage compartment having a mirror secured thereto. In at least this embodiment, the storage bin has a stop tab that is selectively engageable with the stop surface of the actuator to enable the storage bin to selectively pivot to the first or second use position.

In yet at least another embodiment, the vehicle overhead console assembly comprises a console body having an exterior surface facing a first direction and an interior surface facing a second, opposite direction. In at least this embodiment, the first direction faces the occupant compartment when the console assembly is supported in the vehicle and the second direction faces away from the occupant compartment when the console assembly is supported in the vehicle. In at least this embodiment, the console body has a slot extending between the interior and the exterior surfaces. In at least this embodiment, the vehicle overhead console assembly further comprises an actuator slidably supported within the slot of the console body between a first position and a second position. In at least this embodiment, the actuator has a button portion located adjacent the exterior surface, a stop surface located adjacent the interior surface of the console body, and a connector portion extending between and connecting the actuator and the stop surface. In at least this embodiment, the vehicle overhead console assembly further comprises a storage bin pivotally connected to the console body for selective pivotal movement between a stowed position, a first use position, and a second use position. In at least this embodiment, the storage bin has a door which is generally flush with the exterior surface of the console body when the storage bin is in the stowed position, and a base wall extending between two opposed side walls forming a storage compartment in combination with the door with a convex mirror being secured to the base wall. In at least this embodiment, one of the side walls has a stop tab that is selectively engageable with the stop surface of the actuator to enable the storage bin to selectively pivot to the first or second use position, wherein the stop tab is engageable with the stop surface when the actuator is in the first position to enable the mirror to be viewable by an occupant in the occupant compartment while preventing the storage compartment from being accessible by the occupant in the occupant compartment, and the stop tab is not engageable with the stop surface when the actuator is in the second position such that the storage compartment is accessible by the occupant the occupant compartment.

### BRIEF DESCRIPTION OF THE DRAWINGS

FIG. 1A is a bottom perspective view of a vehicle overhead console assembly in accordance with an embodiment of the present invention;

FIG. 1B is an enlarged view of a portion of the vehicle overhead console assembly illustrated in FIG. 1A;

FIG. 2 is a top perspective view of a portion of the vehicle overhead console assembly illustrated in FIG. 1A;

FIG. 3 is a view similar to FIG. 2 showing the vehicle overhead console assembly in a first use position;

FIG. 4 is a sectional view taken along line 4-4 of FIG. 3;

FIG. 5 is a exploded view of a component of the console assembly of FIG. 1A; and

FIG. 6 is a view similar to FIG. 2 showing the vehicle overhead console assembly in a second use position.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The Figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable or preferred for a given purpose in connection with the invention implies that mixtures of any two or more members of the group or class may be equally suitable or preferred.

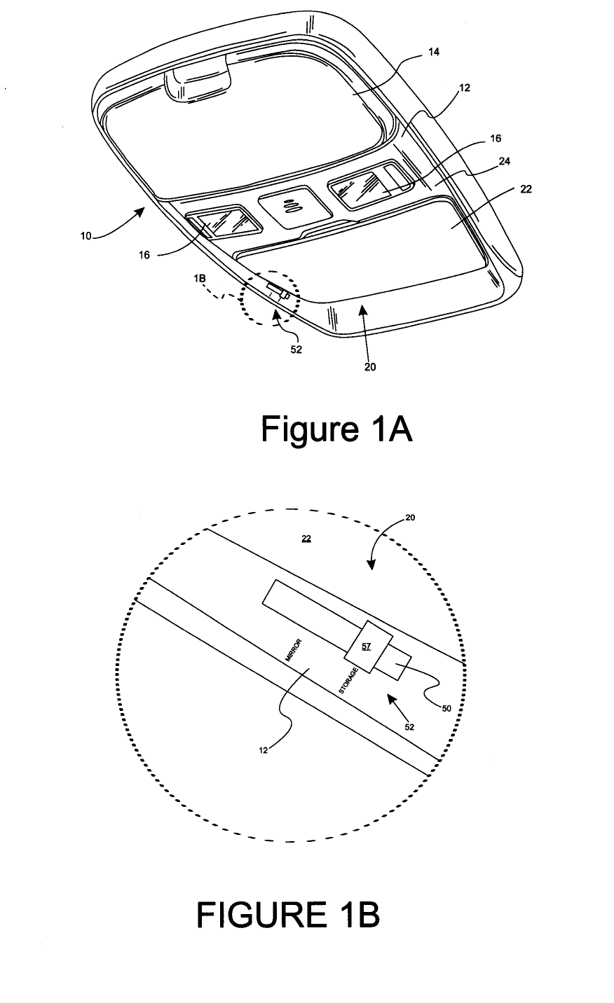

Referring now to the Figures, where like numerals are used to designate like structure throughout the drawings, a bottom perspective view of a vehicle overhead console assembly in accordance with at least one embodiment of the present invention is generally shown at 10 in FIG. 1A. The vehicle overhead console assembly 10 is adapted to be attached to an interior vehicle roof or headliner in a known manner.

The vehicle overhead console assembly 10 include a console body 12 which may be made of any suitable material but is typically an injection molded plastic component. In at least the illustrated embodiment, exemplary storage compartment door 14 and lights 16 are shown attached to the console body 12 for reference. As would be appreciated by those of ordinary skill in the art, the compartment door 14 can be any conventionally pivotable connectable storage bin of various size, shape and design. As would be further appreciated by those of ordinary skill in the art, the vehicle console assembly 10 may be installed in a wide variety of vehicles that may include automobiles, trucks, buses, airplanes, water craft, trains, and the like. Similarly, vehicle console assembly 10 may be located anywhere within the vehicle for convenient access.

Referring to FIG. 1A, a pivotable combination mirror and storage bin assembly 20 is secured to the console body 12. As shown in FIG. 1A, the mirror and storage bin assembly 20 includes a door 22 which is normally flush with the exterior surface 24 of the console body 12 when the mirror and storage bin assembly 20 is in its stowed or stored position.

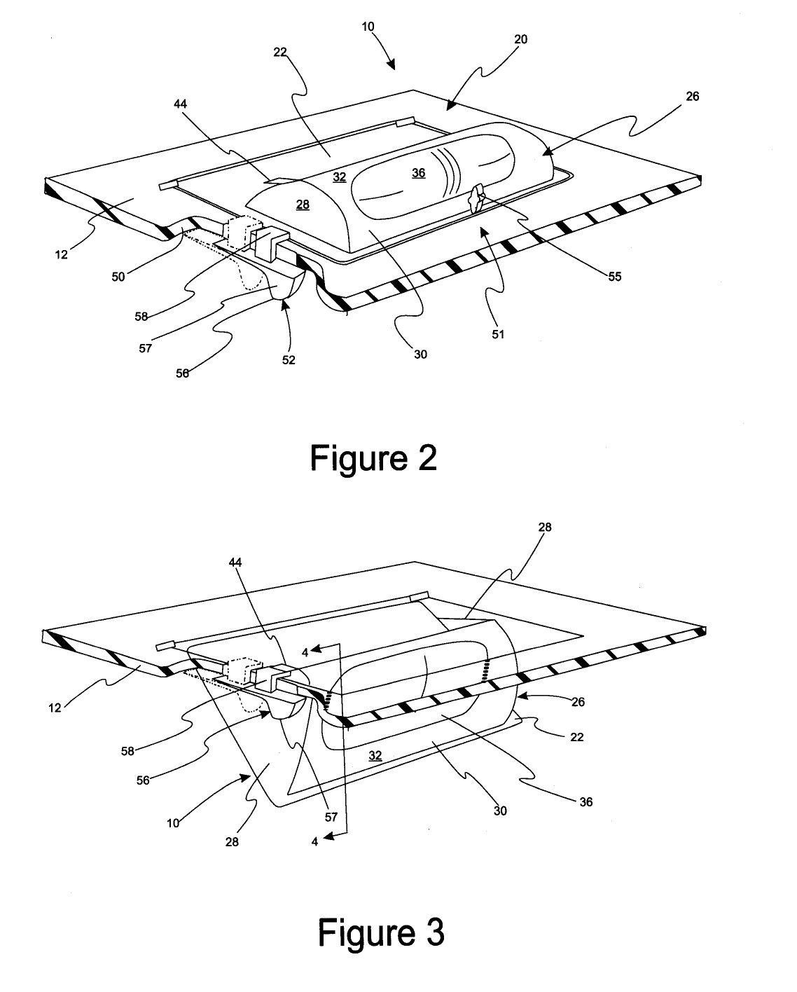

As can be best seen in FIGS. 2, 3 and 6, the mirror and storage bin assembly 20 includes a storage bin 26 generally defined by opposed sidewalls 28 which extend generally transverse from the back surface of the door 22 and a generally arcuate base wall 30 that extends between and connects the opposed sidewalls 28 and the door 22. The base wall 30 includes a front surface 32 upon which a mirror 36 is suitably secured. In an alternative design, the base wall 30 could have an opening therein in which the mirror 36 is supported. The mirror 36 can be any suitable size and shape, however, in at least one embodiment, the mirror 36 is convex. Convex mirrors can reflect a relatively broad rearward field of view to the driver (and/or the other front seat passenger(s), both up and down fields. The convex mirror 36 can be secured in any suitable manner such as adhesive. The base wall 30 also includes a rear surface 38 which together with the rear surface of the door 22 and the inner surfaces of the opposed walls 28 forms a storage bin 40 for receipt of items such as sunglasses and other storageable items such as change, pens, and garage door openers.

In the illustrated embodiment, the left opposed wall 28 (i.e. the wall that faces the driver side) includes a stop tab 44 that extend from the sidewall 28 towards the driver's side of the vehicle. While the stop tab 44 is illustrated as being on the driver's side opposed side wall 28, it should be understood that the stop tab could be disposed on the passenger side as well.

The mirror and storage bin assembly 10 is normally latched in a stored or stowed position, as best illustrated in FIG. 1A. Any suitable latch mechanism 51 can be used. The schematically illustrated latch mechanism 51 include a storage bin latch that is stationary relative to the console body 12 and a striker 55 that is carried by the back surface of the door 22.

As best shown in FIG. 5, the console body 12 includes a slot 50 (only partially shown in FIGS. 2, 3 and 6) for slidably guiding a button assembly 52. The button assembly 52 controls the position of the mirror and storage bin assembly 20 when released from the latch mechanism 51. The button assembly 52 comprises a button 56 that is slidable within the slot 50 in the console body 12. The button 56 include a manipulable portion 57 that faces the occupant and a tab stop 58 that is connected with the manipulable portion 57 and extends away from the manipulable portion towards the opposed sidewall 28 of the bin assembly 26. The manipulable portion 57 is moveable between a first position designated as mirror and a second position designated as storage as best shown in FIG. 1B.

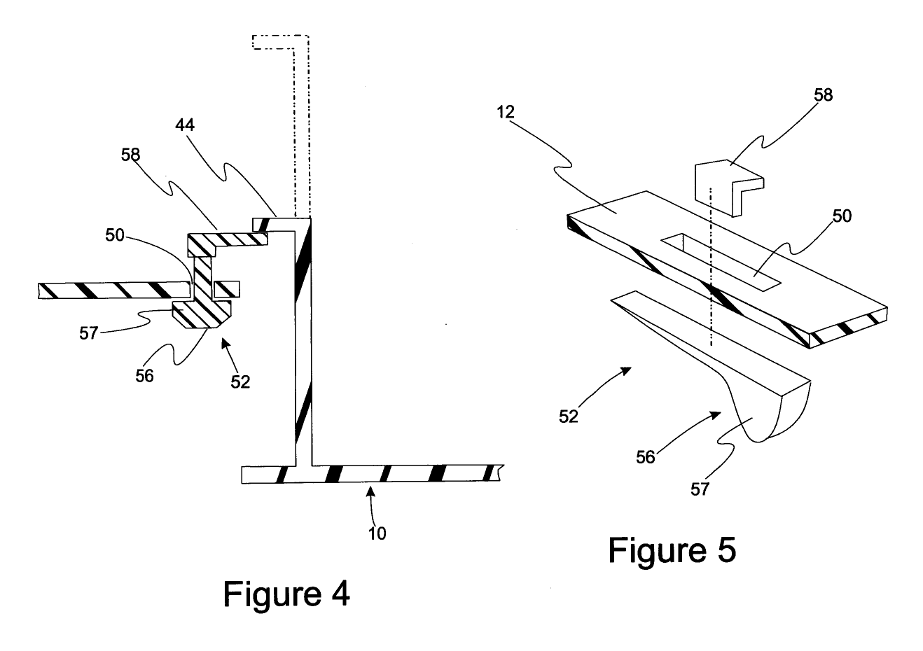

When the button assembly 56 is in the first position designated mirror and the door 22 is disengaged from the latch, the door will rotate into the passenger compartment until the tab stop 44 engages the tab stop 58 as best shown in FIG. 4. In this position, the mirror 36 is in a first use position so that the front passenger(s) can view other passengers or objects in the rear of the vehicle.

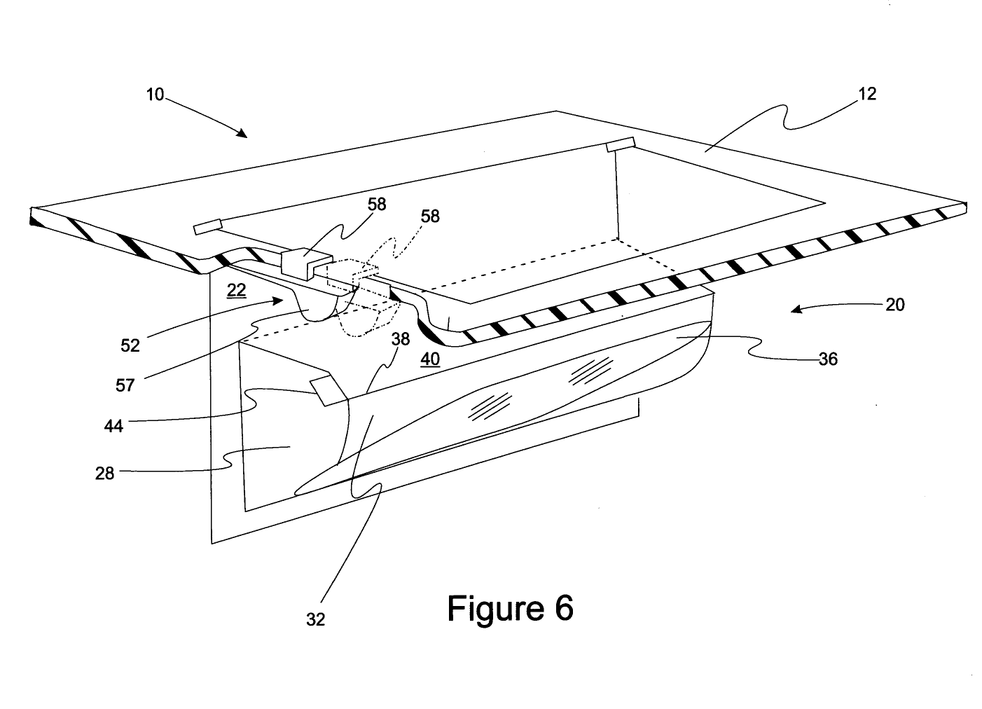

When the button assembly 56 is slid back into the second position, the tab stop 44 on the sidewall 28 of the storage compartment 26 does not engage the tab stop 58 on the button assembly 56 thereby allowing the door to pivot to a further position within the occupant compartment as shown in FIG. 6. As illustrated in FIG. 6, the storage bin 40 is accessible by occupants to put components such as sunglasses and other storable component therein. The storage bin/mirror assembly 20 includes a biasing component, such as a spring to urge the storage bin/mirror assembly 20 away from the household body 12 and into the occupant compartment.

While embodiments of the invention have been illustrated and described, it is not intended that these embodiments illustrate and describe all possible forms of the invention. Moreover, the words used in the specification are words of description rather than limitation, and it is understood that various changes may be made without departing from the spirit and scope of the invention.

What is claimed is:

1. A vehicle overhead console assembly supportable in a vehicle having an occupant compartment, the console assembly comprising:
a console body having an exterior surface facing a first direction and an interior surface facing a second, opposite direction, the first direction facing the occupant compartment when the console assembly is supported in the vehicle and the second direction facing away from the occupant compartment when the console assembly is supported in the vehicle;
an actuator slidably supported by the console body between a first position and a second position, the actuator having a button portion located adjacent the exterior surface, a stop surface located adjacent the interior surface of the console body, and a connector portion extending between and connecting the actuator and the stop surface; and
a storage bin pivotally connected to the console body, the storage bin being pivotally movable between a stowed position, a first use position, and a second use position, the storage bin having a door which is generally flush with the exterior surface of the console body when the storage bin is in the stowed position, the storage bin having at least one wall forming a storage compartment in combination with the door, the wall having a mirror secured thereto, the storage bin having a stop tab that is selectively engageable with the stop surface of the actuator to enable the storage bin to selectively pivot to the first or second use position.

2. The vehicle overhead console assembly of claim 1 wherein the stop tab is engageable with the stop surface when the actuator is in the first position such that the mirror is viewable by an occupant in the occupant compartment while the storage compartment is not accessible by an occupant in the occupant compartment.

3. The vehicle overhead console assembly of claim 1 wherein the storage bin has opposed side walls that extend between the door and opposed ends of the at least one wall.

4. The vehicle overhead console assembly of claim 3 wherein the stop tab is located on one of the opposed end walls.

5. The vehicle overhead console assembly of claim 4 wherein the stop tab is located on the opposed end wall closer to the driver's side.

6. The vehicle overhead console assembly of claim 1 wherein the mirror is convex.

7. The vehicle overhead console assembly of claim 1 wherein the stop tab is not engageable with the stop surface when the actuator is in the second position such that the storage compartment is accessible by an occupant in the occupant compartment.

8. The vehicle overhead console assembly of claim 1 wherein the console body includes a slot for slidably supporting the actuator for movement between the first and second positions, the connector portion extending through the slot.

9. The vehicle overhead console assembly of claim 1 further comprising a hinge mechanism for maintaining the storage bin in the stowed position.

10. The vehicle overhead console assembly of claim 9 wherein the hinge mechanism comprises a striker on the door and a latch on the console body, the striker being disengageable from the latch to allow the bin to pivot from the stowed position to the first or second use positions.

11. The vehicle overhead console assembly of claim 10 further comprising a biasing member for using the bin towards the first and second use positions.

12. A vehicle overhead console assembly supportable in a vehicle having an occupant compartment, the console assembly comprising:
a console body having an exterior surface facing a first direction and an interior surface facing a second, opposite direction;
an actuator slidably supported by the console body between a first position and a second position, the actuator having a stop surface; and
a storage bin pivotally connected to the console body, the storage bin being pivotally movable between a stowed position, a first use position, and a second use position, the storage bin having a door having at least a substantial portion flush with the exterior surface of the console body when the storage bin is in the stowed position, the storage bin having a storage compartment having a mirror secured thereto, the storage bin having a stop tab that is selectively engageable with the stop surface of the actuator to enable the storage bin to selectively pivot to the first or second use position.

13. The vehicle overhead console assembly of claim 12 wherein the stop tab is engageable with the stop surface when the actuator is in the first position such that the mirror is viewable by an occupant in the occupant compartment while the storage compartment is not accessible by an occupant in the occupant compartment.

14. The vehicle overhead console assembly of claim 13 wherein the storage bin comprises an arcuate base wall and two opposed side walls extending between the door and the base wall to form the storage compartment, the mirror being supported on the base wall.

15. The vehicle overhead console assembly of claim 14 wherein the stop tab is located on one of the opposed end walls.

16. The vehicle overhead console assembly of claim 15 wherein the mirror is convex.

17. The vehicle overhead console assembly of claim 15 wherein the stop tab is not engageable with the stop surface when the actuator is in the second position such that the storage compartment is accessible by an occupant in the occupant compartment.

18. The vehicle overhead console assembly of claim 17 wherein the console body includes a slot for slidably supporting the actuator for movement between the first and second positions, the connector portion extending through the slot.

19. The vehicle overhead console assembly of claim 18 further comprising a biasing member for using the bin towards the first and second use positions.

20. A vehicle overhead console assembly supportable in a vehicle having an occupant compartment, the console assembly comprising:
a console body having an exterior surface facing a first direction and an interior surface facing a second, opposite direction, the first direction facing the occupant compartment when the console assembly is supported in the vehicle and the second direction facing away from the occupant compartment when the console assembly is supported in the vehicle, the console body having a slot extending between the interior and the exterior surfaces;
an actuator slidably supported within the slot of the console body between a first position and a second position, the actuator having a button portion located adjacent the exterior surface, a stop surface located adjacent the interior surface of the console body, and a connector portion extending between and connecting the actuator and the stop surface; and
a storage bin pivotally connected to the console body, the storage bin being selectively pivotally movable between a stowed position, a first use position, and a second use position, the storage bin having a door which is generally flush with the exterior surface of the console body when the storage bin is in the stowed position, the storage bin having a base wall extending between two opposed side walls forming a storage compartment in combination with the door, the wall having a convex mirror secured thereto, one of the side walls having a stop tab that is selectively engageable with the stop surface of the actuator to enable the storage bin to selectively pivot to the first or second use position;
the stop tab being engageable with the stop surface when the actuator is in the first position to enable the mirror to be viewable by an occupant in the occupant compartment while preventing the storage compartment from being accessible by the occupant in the occupant compartment; and
the stop tab not being engageable with the stop surface when the actuator is in the second position such that the storage compartment is accessible by the occupant the occupant compartment.
